(19) United States
(12) Patent Application Publication
(10) Pub. No.: US 2026/0346449 A1
(43) Pub. Date: Nov. 5, 2026

(54) ROBOT SYSTEM SIMULATION DEVICE

(71) Applicant: FANUC CORPORATION, Minamitsuru-gun, Yamanashi (JP)

(72) Inventor: Daiki YAMAGUCHI, Yamanashi (JP)

(73) Assignee: FANUC CORPORATION, Minamitsuru-gun, Yamanashi (JP)

(21) Appl. No.: 19/121,218

(22) PCT Filed: Nov. 29, 2022
(86) PCT No.: PCT/JP2022/044016

§ 371 Date: Apr. 15, 2025

(51) Int. Cl. B25J 9/16

(52) U.S. Cl. CPC B25J 9/1676; B25J 9/1671; B25J 9/1694

(57) ABSTRACT

A robot system simulation device including at least one robot, at least one sensor for detecting a moving body within a detection area around the robot, and at least one control device for controlling the robot, in which a control device corresponding to a sensor slows down or stops operation of a robot when the sensor detects the moving body, and wherein the robot system simulation device additionally comprises at least one processor, at least one piece of memory, and an input device, the memory serves to store layout information regarding a robot system, the input device receives input of movement information regarding the moving body, and the processor executes a simulation of operation of the robot system on the basis of the layout information and the movement information and calculates the operation delay time relative to a case in which no moving object is detected in the detection area.

### TECHNICAL FIELD

The present disclosure relates to a simulation device for a robot system.

### BACKGROUND ART

There is a robot system that performs control so as to decelerate or stop the operation of a robot when a cooperating worker has come closer to the robot in operation than a prescribed distance.

In addition, there is a simulation device for such a robot system, which simulates the operation of a robot and a cooperating worker in order to reduce the time during which the robot is decelerated or stopped (for example, see Patent Literature 1).

### CITATION LIST

### Patent Literature

{PTL 1} Japanese Unexamined Patent Application, Publication No. 2017-24113

### SUMMARY OF INVENTION

### Technical Problem

However, in general, there is a case in which a moving body, such as an automated guided vehicle, that performs a task different from that of the robot system enters or stays within the operating range of the robot. In this case also, the moving body is detected by a sensor, whereby the operation of the robot decelerates or stops, and the cycle time of the robot system increases.

Therefore, it is desirable to keep the cycle time of the robot system within a desired time even when a moving body other than the originally arranged moving body, such as a cooperating worker, is present within the operating range of the robot.

### Solution to Problem

An aspect of the present disclosure is a simulation device for a robot system including at least one robot, at least one sensor for detecting a moving body in a detection area around the robot, and at least one control device for controlling the robot, wherein the control device corresponding to the sensor decelerates or stops an operation of the robot in response to the sensor detecting the moving body, the simulation device including at least one processor, at least one memory, and an input device, wherein: the memory stores layout information on the robot system; the input device receives input of movement information on the moving body; and the processor executes simulation of an operation of the robot system on a basis of the layout information and the movement information, and calculates a delay time of the operation with respect to a case in which the moving body is not detected in the detection area.

### BRIEF DESCRIPTION OF DRAWINGS

FIG. 1 is a plan view showing a layout of a robot system to which a simulation device according to an embodiment of the present disclosure is applied.

FIG. 2 is a block diagram showing the simulation device according to the embodiment of the present disclosure.

FIG. 3 is a flowchart for explaining a simulation method using the simulation device in FIG. 2.

FIG. 4 is a time chart showing the operation of a robot in a case in which a moving body is not present in a photographing range in the robot system in FIG. 1.

FIG. 5 is a time chart showing movement information input to the simulation device in FIG. 2.

FIG. 6 is a time chart showing the operation of the robot in consideration of the entry of a moving body into the photographing range in the robot system in FIG. 1.

FIG. 7 is a plan view showing a modification of the layout of the robot system in FIG. 1.

### DESCRIPTION OF EMBODIMENT

A simulation device 1 for a robot system 10 according to an embodiment of the present disclosure will be described below with reference to the drawings.

First, the robot system 10 to which the simulation device 1 of this embodiment is applied will be described.

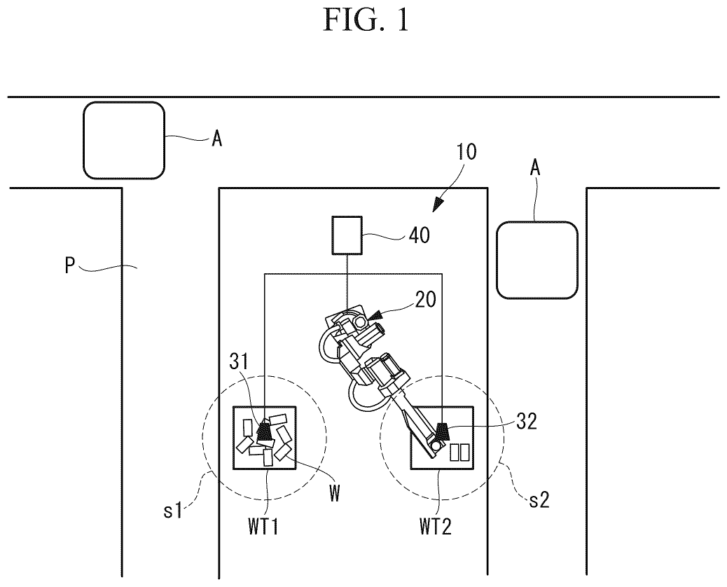

As shown in FIG. 1, the robot system 10 includes: at least one robot 20; at least one camera (sensor) 31, 32 for photographing the periphery of the robot 20; and at least one control device 40. In FIG. 1, a portion of the robot system 10 is shown to simplify the description, and one robot 20, two cameras 31, 32, and one control device 40 provided in the robot system 10 are shown.

The robot 20 is, for example, a six-axis articulated robot. The robot 20 is installed between two work tables WT1, WT2 that are arranged so as to be spaced apart in the horizontal direction. In addition, the robot 20 performs, for example, a task of picking a plurality of workpieces W randomly stacked on the work table WT1 one by one and moving the workpieces W to the work table WT2.

The cameras 31, 32 are, for example, two-dimensional cameras that acquire two-dimensional images. In addition, the cameras 31, 32 are installed above the work tables WT1, WT2 so as to face downward, and respectively have conical photographing ranges (detection areas) s1, s2 at positions including the work tables WT1, WT2. With this configuration, the cameras 31, 32 can acquire two-dimensional images of the photographing ranges s1, s2 at a prescribed frame rate.

The control device 40 includes at least one processor (not shown) and a memory (not shown), such as a RAM and a ROM, and is connected to the robot 20 and the cameras 31, 32.

An operation program for operating the robot 20 is stored in the memory of the control device 40. In addition, the processor of the control device 40 executes the operation program stored in the memory to operate each shaft of the robot 20, thereby causing the robot 20 to execute a desired task.

In addition, the control device 40 transmits, to one of the cameras 31, 32 corresponding to the orientation of the robot 20, a photographing command for causing the camera 31, 32 to execute photographing at a prescribed frame rate. In other words, the control device 40 causes the camera 31, 32 on the side where a wrist of the robot 20 is directed to acquire a two-dimensional image, and receives the two-dimensional image.

In addition, the control device 40 performs image processing on the received two-dimensional image to extract all moving bodies included in the two-dimensional image.

Then, the control device 40 excludes the robot 20 (including a tool or the like attached to the robot 20) from the extracted moving bodies, and determines whether or not a moving body A other than the robot 20 is included. In a case in which the moving body A other than the robot 20 is included in all the extracted moving bodies, the control device 40 decelerates or stops the operation of each shaft of the robot 20. In other words, the cycle time of the robot system 10 is delayed by the time during which the operation of the robot 20 is decelerated or stopped.

Next, the simulation device 1 according to the embodiment of the present disclosure will be described with reference to the drawings.

The simulation device 1 according to this embodiment is implemented by a computer, such as a personal computer.

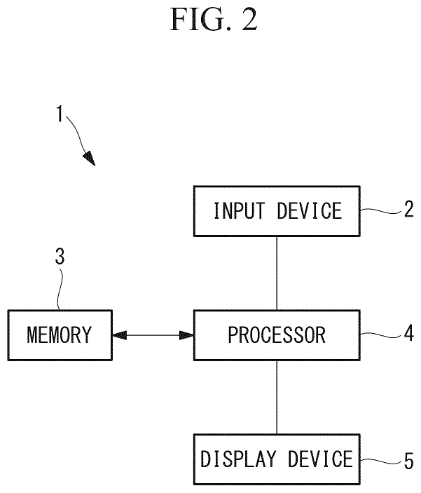

For example, as shown in FIG. 2, the simulation device 1 includes an input device 2, a memory 3 such as a ROM and a RAM, at least one processor 4 such as a CPU, and a display device 5.

The input device 2 is constituted of, for example, a keyboard, a touch panel, an operation panel, a serial interface such as a USB, and so forth. In addition, the input device 2 receives movement information on at least one moving body A, which is input by an operator operating the simulation device 1. The movement information is, for example, information including a movement path of the moving body A and time at each position in the movement path, based on the operation program start time for the robot system 10.

The memory 3 stores layout information on the robot system 10 in a factory. The layout information is, for example, information including positions and sizes of the individual constituent elements of the robot system 10, the work tables WT1, WT2, and the photographing ranges s1, s2, as well as information pertaining to the position, shape, etc. of a passage P in the vicinity of the robot 20. All of these items of layout information are three-dimensionally modeled and stored in the memory 3.

In addition, the memory 3 stores a simulation program and an operation program for the robot system 10. When the simulation program is executed by the processor 4, which will be described later, the operation program for the robot system 10 is executed in a virtual space on the computer.

Furthermore, the memory 3 stores an ideal cycle time of the robot system 10, that is, a cycle time in a case in which the moving body A does not enter the photographing range s1, s2 and the operation of the robot 20 does not decelerate or stop. The memory 3 also stores the movement information on the moving body A input to the input device 2.

The processor 4 takes out the movement information on the moving body A and the layout information on the robot system 10, which are stored in the memory 3, and determines, on the basis of the both items of information, whether or not the movement path of the moving body A overlaps the photographing range s1, s2.

In addition, the processor 4 executes the simulation program stored in the memory 3, thereby arranging the robot system 10 and the passage P in the vicinity thereof, and the moving body A moving on the passage P in the virtual space on the computer. Then, the processor 4 uses the movement information and the layout information taken out from the memory 3 to execute the operation program for the robot system 10 arranged in the virtual space and simulation of motion of the moving body A.

Furthermore, the processor 4 calculates, from the simulation result, a cycle time of the operation program in consideration of an operation delay of the robot 20 caused by the moving body A entering the photographing range s1, s2.

The display device 5 is constituted of a liquid crystal display or the like. On the basis of the layout information, the processor 4 causes the display device 5 to display the robot system 10 and the layout in the periphery thereof, and the photographing ranges s1, s2 in a superimposed manner. In addition, the processor 4 causes the display device 5 to display, for example, a delay time calculated by comparing the calculated cycle time of the operation program with the ideal cycle time stored in the memory 3, together with the displayed layout information.

The operation of the thus-configured simulation device 1 according to this embodiment will be described below.

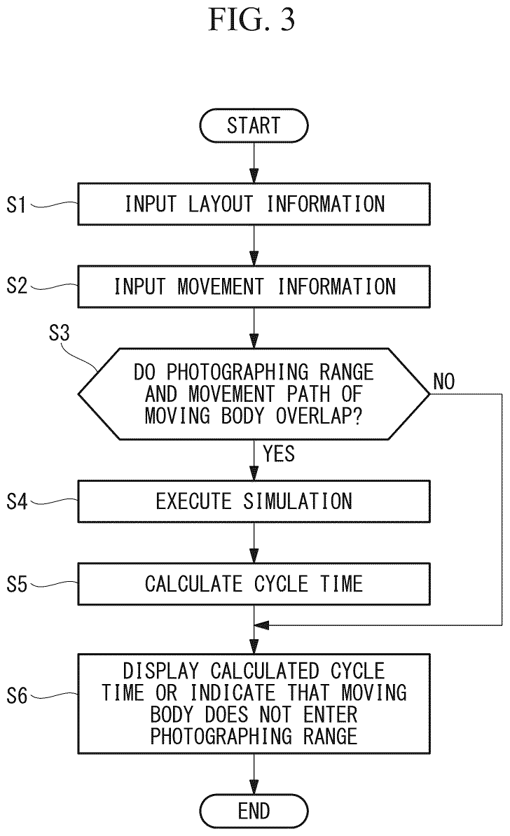

In the following, a method of simulating the operation of the robot system 10 shown in FIG. 1 will be described as an example along the flowchart shown in FIG. 3.

First, the operator operating the simulation device 1 inputs the layout information on the robot system 10 to the input device 2 (step S1). By doing so, a three-dimensional model showing the passage P in the vicinity of the robot 20 and the relative positional relationship of the individual constituent elements of the robot system 10 and the photographing ranges s1, s2 with respect to the passage P is stored in the memory 3. In addition, the operator inputs, together with the layout information, the operation program for the robot system 10 and the ideal cycle time of the operation program, which has been calculated in advance, to the input device 2 so as to be stored in the memory 3.

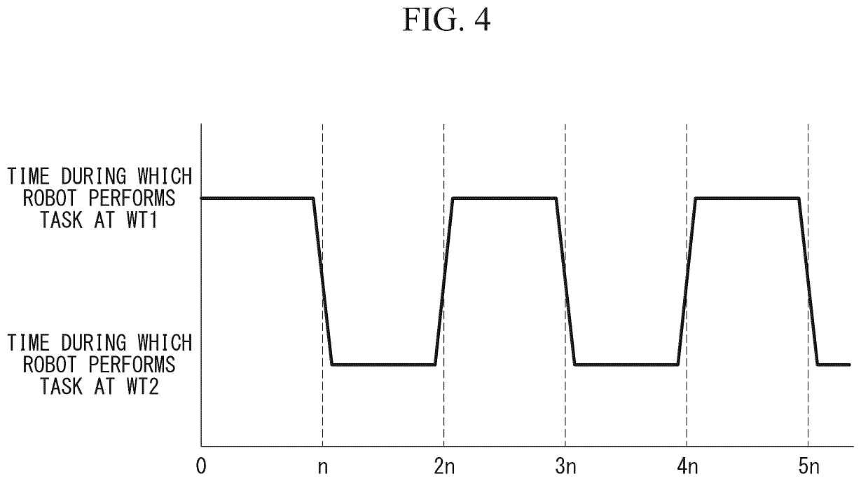

The example shown in FIG. 4 is an example time chart of the operation program input to the input device 2, in which the robot 20 is caused to execute a desired task by reciprocating the wrist tip of the robot 20 between the work tables WT1, WT2 at an interval of n seconds.

Next, the operator inputs, as the movement information on all moving bodies A moving in the passage P in the vicinity of the robot 20, the movement path of each moving body A and time at each position in the movement path to the input device 2 (step S2). The input movement information is stored in the memory 3.

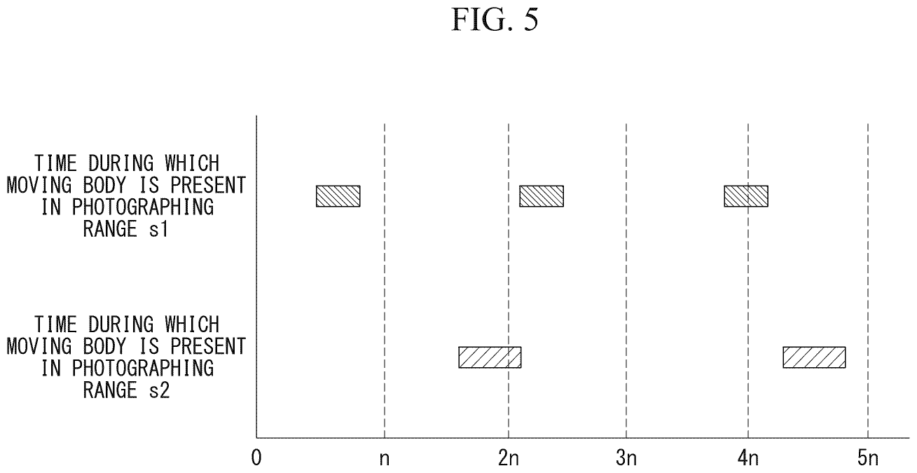

In this state, the processor 4 takes out the layout information and the movement information stored in the memory 3, and compares the two items of information. Then, the processor 4 determines whether or not the movement path of the moving body A included in the movement information overlaps the photographing range s1, s2 included in the layout information (step S3). In a case in which it is determined that the movement path and the photographing range s1, s2 overlap, the processor 4 extracts an overlapping time zone and stores the time zone in the memory 3. In other words, as shown in FIG. 5, the memory 3 stores the time zones during which the moving body A is present in the individual photographing ranges s1, s2 with respect to the elapsed time from the operation program start time for the robot system 10.

Subsequently, the processor 4 executes the simulation program stored in the memory 3 (step S4).

When the simulation program is executed, the processor 4 sets the robot system 10, the passage P, and the moving body A in the virtual space on the computer on the basis of the layout information read out from the memory 3. Then, the processor 4 causes the robot system 10 to operate according to the operation program and also causes the moving body A to move on the basis of the movement information in the virtual space.

In this case, for example, when the robot 20 is performing a task with the wrist tip directed to the work table WT1 side, the entry of the moving body A into the photographing range s1 causes the robot 20 to stop or decelerate. Because of this, as shown in FIGS. 4 to 6, the operation program is delayed by the time during which the operation of the robot 20 is stopped or decelerated while the robot 20 is performing the task on the work table WT1 side.

Similarly, when the robot 20 is performing a task with the wrist tip directed to the work table WT2 side, the entry of the moving body A into the photographing range s2 causes the robot 20 to stop or decelerate, and the operation program is delayed by the time during which the robot 20 is stopped or decelerated.

The processor 4 calculates a cycle time of the operation program delayed as a result of the moving body A entering the photographing range s1, s2 (step S5). In addition, the processor 4 calculates a delay time of the operation program by comparing the cycle time calculated from the simulation result with the ideal cycle time stored in the memory 3. In this process, a delay time while the robot 20 is performing the task on the work table WT1 side and a delay time while the robot 20 is performing the task on the work table WT2 side are separately calculated.

Then, the processor 4 causes the display device 5 to display the calculated cycle time and delay time together with the layout information stored in the memory 3 (step S6). For example, the display device 5 displays the respective delay times calculated by the processor 4, which are caused by the entry of the moving body A into the photographing ranges s1, s2, in association with the photographing ranges s1, s2 displayed on the basis of the layout information.

Meanwhile, in a case in which the processor 4 determines that the movement path of the moving body A and the photographing range s1, s2 do not overlap (step S3), the execution of the simulation program described above is omitted. Then, the processor 4 causes the display device 5 to indicate that the moving body A does not enter the photographing range s1, s2 (step S6).

As described above, the operator can confirm whether or not there is a possibility that the cycle time of the robot system 10 is delayed by checking the display device 5. In addition, when there is a possibility that the cycle time is delayed, it is possible to confirm the delay time of the operation program for the robot system 10, which is calculated from the simulation result and displayed on the display device 5.

Therefore, the operator can determine whether or not the cycle time exceeds a desired time on the basis of the display on the display device 5. In addition, in a case in which the cycle time exceeds the desired time, it is possible to change the layout of the robot system 10 to reduce the delay time of the operation program.

In this case, the operator can grasp, in a distinguishable manner, the delay time caused by the moving body A entering the photographing range s1 and the delay time caused by the moving body A entering the photographing range s2, on the basis of the display on the display device 5.

Thus, it is possible to preferentially reduce, of the two delay times, the delay time having a greater influence on the cycle time, and to more efficiently change the layout of the robot system 10.

For example, in a case in which most of the delay of the cycle time is due to the delay time on the photographing range s1 side in the robot system 10 in FIG. 1, the entire robot system 10 may be arranged away from the passage P adjacent to the work table WT1.

Note that, although the movement path of the moving body A and time at each position in the movement path are input to the input device 2 as the movement information in this embodiment, the movement information is not limited thereto.

For example, in a case in which the number of times the moving body A enters the photographing range s1, s2 per unit time and a staying time per entry have been obtained, these items of information may be input to the input device 2 as the movement information.

In this case, the processor 4 multiplies the number of times the moving body A enters the photographing range s1, s2 by the staying time per entry. By doing so, the processor 4 calculates the cumulative staying time of the moving body A in the photographing range s1 per unit time and the cumulative staying time of the moving body A in the photographing range s2 per unit time.

The longer the cumulative staying time is, the longer the delay time given to the cycle time of the operation program may be, and thus, it is possible to estimate that the delay time proportional to the cumulative staying time is generated in each of the photographing ranges s1, s2.

Therefore, the processor 4 may execute simulation of the operation program and calculate the cycle time in consideration of the delay time proportional to the cumulative staying time of the moving body A in each of the photographing ranges s1, s2.

In addition, in a case in which the frequency of the moving body A entering the photographing range s1, s2 per unit time and the staying time per entry have been obtained as a plurality of classified levels, these levels may be used as the movement information.

For example, in a case in which the frequency of the moving body A entering the photographing range s1, s2 and the staying time per entry are each classified into five levels, scores corresponding to the magnitudes of levels are assigned to the respective levels. Then, by multiplying the score assigned to the level of the entry frequency by the score assigned to the level of the staying time and by obtaining the sum thereof, it is possible to estimate the cumulative staying time of the moving body A in each of the photographing ranges s1, s2.

In this embodiment, in the case in which the cycle time of the robot system 10 exceeds a desired time, the delay time of the operation program is reduced by changing the layout of the robot system 10. Instead, the delay time may be reduced by changing the operation program for the robot system 10 without changing the layout of the robot system 10.

Alternatively, the delay time may be reduced by changing the movement method of the moving body A moving in the passage P, that is, the movement path, moving speed, or the like of the moving body A.

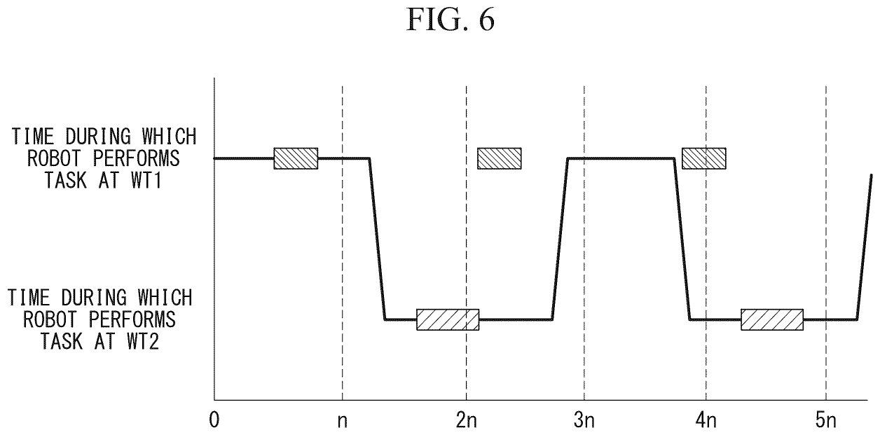

In this case, as shown in FIG. 6, the display device 5 may display, on the basis of the simulation result, the time zones during which the operation of the robot 20 is stopped in correspondence with the time of the operation program.

With this configuration, the operator can grasp the timings at which the operation of the robot 20 is stopped in the operation program being executed. Therefore, the operator may change the operation program for the robot system 10 or the movement method of the moving body A so that the moving body A enters the photographing range s1, s2 while avoiding said timings.

In addition, although the robot system 10 to which the simulation device 1 is applied has the two photographing ranges s1, s2 in this embodiment, one photographing range or three or more photographing ranges may be provided.

In addition, in this embodiment, the simulation device 1 is applied to the robot system 10 in which the cameras 31, 32 are respectively installed above the work tables WT1, WT2.

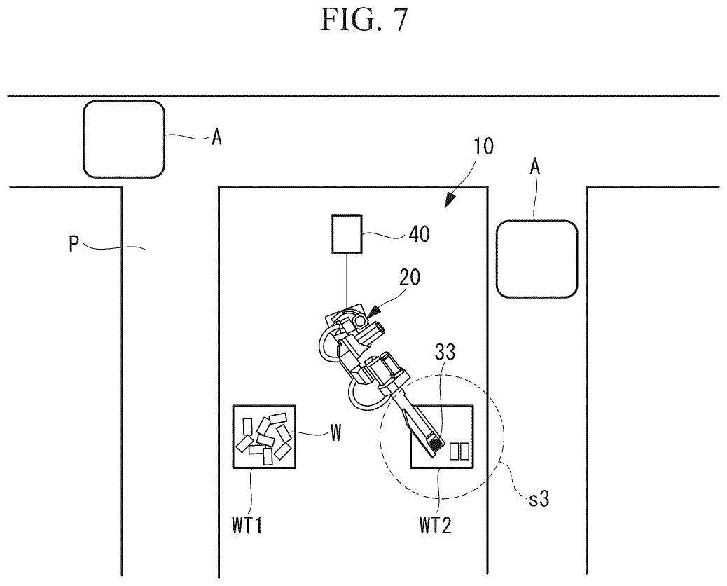

Alternatively, as shown in FIG. 7, the simulation device 1 may be applied to a robot system 10 provided with one camera (sensor) 33 that is fixed to the wrist of the robot 20 and that has a photographing range (detection area) s3 in the periphery of the wrist tip.

In addition, in this embodiment, the robot system 10 to which the simulation device 1 is applied includes the cameras 31, 32 that are respectively arranged above the work tables WT1, WT2. Because of this, the photographing ranges s1, s2 respectively spread in a conical shape downward from above the work tables WT1, WT2. In other words, it is necessary to consider that the photographing ranges s1, s2 for detecting the moving body A change in the height direction.

Alternatively, an area sensor or the like in which a plurality of line sensors are arranged adjacent to each other may be employed as the cameras 31, 32 of the robot system 10 to which the simulation device 1 is applied.

In this case, the size of the photographing range s1, s2 is constant in the height direction. Thus, the simulation device 1 can two-dimensionally determine the overlap between the moving body A and the photographing range s1, s2. Therefore, even if the layout information input to the input device 2 is a two-dimensional model, the accuracy of the simulation of the operation program is not deteriorated.

Although the embodiments of the present disclosure have been described in detail above, the present disclosure is not limited to the individual embodiments described above. In these embodiments, various addition, replacement, alteration, partial deletion, and so forth can be made within a range that does not depart from the scope of the invention, or within a range that does not depart from the concept and spirit of the present invention derived from the content set forth in the claims and the equivalents thereof. For example, in the embodiments described above, the order of the individual operations and the order of the individual processes have been illustrated as an example, and the orders are not limited thereto.

In regard to the abovementioned embodiments and modifications, the following appendices are further disclosed.

### Appendix 1

A simulation device 1 for a robot system 10 comprising at least one robot 20, at least one sensor 31, 32, 33 for detecting a moving body in a detection area s1, s2, s3 around the robot 20, and at least one control device 40 for controlling the robot 20, wherein the control device 40 corresponding to the sensor 31, 32, 33 decelerates or stops an operation of the robot 20 in response to the sensor 31, 32, 33 detecting the moving body A, the simulation device 1 comprising at least one processor 4, at least one memory 3, and an input device 2, wherein: the memory 3 stores layout information on the robot system 10; the input device 2 receives input of movement information on the moving body A; and the processor 4 executes simulation of an operation of the robot system 10 on a basis of the layout information and the movement information, and calculates a delay time of the operation with respect to a case in which the moving body A is not detected in the detection area s1, s2, s3.

### Appendix 2

The simulation device 1 for the robot system 10 according to Appendix 1, wherein the processor 4 calculates a cycle time of the operation of the robot system 10.

### Appendix 3

The simulation device 1 for the robot system 10 according to Appendix 1 or 2, the simulation device 1 further comprising a display device 5 for displaying the layout information, wherein the processor 4 causes the display device to display, on a basis of the movement information and the layout information, an area s1, s2, s3 in which the moving body A is detected by the sensor 31, 32, 33 so as to be superimposed on the layout information.

### Appendix 4

The simulation device 1 for the robot system 10 according to any one of Appendices 1 to 3, wherein the movement information includes a movement path of the moving body A and time at which the moving body A is present at each position in the movement path.

### Appendix 5

The simulation device 1 for the robot system 10 according to any one of Appendices 1 to 3, wherein the movement information includes a number of times the moving body A enters the detection area s1, s2, s3 per unit time and a staying time per entry.

### Appendix 6

The simulation device 1 for the robot system 10 according to any one of Appendices 1 to 3, wherein: the movement information includes a number of times the moving body A enters the detection area s1, s2, s3 and a staying time per entry, each of which is classified into a plurality of levels; and the processor 4 estimates the delay time on a basis of a sum value of values obtained by respectively quantifying the levels.

### Appendix 7

The simulation device 1 for the robot system 10 according to any one of Appendices 1 to 6, wherein: the processor 4 determines whether or not there is a possibility that the moving body A enters the detection area s1, s2, s3 on the basis of the movement information input to the input device 2; and in response to determining that there is a possibility of the moving body A entering the detection area s1, s2, s3, the processor 4 executes the simulation.

### REFERENCE SIGNS LIST

1 simulation device
2 input device
3 memory
4 processor
5 display device
10 robot system
20 robot
31 camera (sensor)
32 camera (sensor)
33 Camera (sensor)
40 control device
A moving body
s1 photographing range (detection area)
s2 photographing range (detection area)
s3 photographing range (detection area)

1. A simulation device for a robot system comprising at least one robot, at least one sensor for detecting a moving body in a detection area around the robot, and at least one control device for controlling the robot, wherein the control device corresponding to the sensor decelerates or stops an operation of the robot in response to the sensor detecting the moving body,
the simulation device comprising at least one processor, at least one memory, and an input device, wherein:
the memory stores layout information on the robot system;
the input device receives input of movement information on the moving body; and
the processor executes simulation of an operation of the robot system on a basis of the layout information and the movement information, and calculates a delay time of the operation with respect to a case in which the moving body is not detected in the detection area.

2. The simulation device for the robot system according to claim 1, wherein the processor calculates a cycle time of the operation of the robot system.

3. The simulation device for the robot system according to claim 1, the simulation device further comprising a display device for displaying the layout information,
wherein the processor causes the display device to display, on a basis of the movement information and the layout information, an area in which the moving body is detected by the sensor so as to be superimposed on the layout information.

4. The simulation device for the robot system according to claim 1, wherein the movement information includes a movement path of the moving body and time at which the moving body is present at each position in the movement path.

5. The simulation device for the robot system according to claim 1, wherein the movement information includes a number of times the moving body enters the detection area per unit time and a staying time per entry.

6. The simulation device for the robot system according to claim 1, wherein:
the movement information includes a number of times the moving body enters the detection area and a staying time per entry, each of which is classified into a plurality of levels; and
the processor estimates the delay time on a basis of a sum value of values obtained by respectively quantifying the levels.

7. The simulation device for the robot system according to claim 1, wherein:
the processor determines whether or not there is a possibility that the moving body enters the detection area on a basis of the movement information input to the input device; and
in response to determining that there is a possibility of the moving body entering the detection area, the processor executes the simulation.
